(19) United States
(12) Patent Application Publication
(10) Pub. No.: US 2006/0248240 A1
(43) Pub. Date: Nov. 2, 2006

(54) MULTI MODE DMA CONTROLLER WITH TRANSFER PACKET PREPROCESSOR

(76) Inventor: Kohji Ishii, Omihachiman (JP)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 11/380,719

(22) Filed: Apr. 28, 2006

(30) Foreign Application Priority Data
Apr. 28, 2005 (JP) 2005132242

(51) Int. Cl. G06F 13/28

(52) U.S. Cl. 710/22

(57) ABSTRACT

A DMA controller capable of employing a plurality of data transfer modes and a data transferring method for the same. A preprocessor generates a designating packet in accordance with a specific data transfer mode, and provides the designating packet for a memory/peripheral device transfer engine and a peripheral device/memory transfer engine. The designating packet includes a transfer direction identification parameter, a transfer start memory address, an address increment/decrement flag, a tag identification flag, a tag transfer identification flag and a transfer word count. In accordance with this designating packet, the transfer engines transfer data between the memory and the peripheral device.

### FIELD OF THE INVENTION

The present invention relates to a direct memory access (DMA) controller and a data transferring method for the same. More particularly, the invention relates to a DMA controller corresponding to a plurality of transferring modes and a data transferring method for the same.

### BACKGROUND OF THE INVENTION

A DMA controller is an LSI (Large Scale Integrated circuit) for transferring data, without a CPU (Central Processing Unit), between a memory mounted on a motherboard and a peripheral device, such as a flexible disk drive, a hard disk drive or a printer. The DMA controller generally includes a plurality of communication paths (DMA channels), and one apparatus occupies one channel.

In a DMA controller compatible with multiple channels, a DMA request/approval handler provides arbitration for DMA channel use. Specifically, the DMA request/approval handler accepts a request and determines whether a DMA channel is available to provide a service, and a transfer engine, which is used in common, transfers data to the thus selected DMA channel.

For a few transfer modes (e.g., only about two modes), the transfer engine can cope with all the transfer modes. When there are many transfer modes (seven or more modes), however, it is difficult for the transfer engine to accommodate every transfer mode because the overall complexity and circuit area of the transfer engine circuitry would increase substantially.

### SUMMARY OF THE INVENTION

The invention provides a DMA controller capable of operating with a plurality of transfer modes and a data transfer method for the same, without employment of a complicated transfer engine.

A DMA controller according to the present invention comprises a preprocessor, a buffer and a transfer engine. The preprocessor generates a designating packet in compliance with a plurality of differing transfer modes. The buffer is connected between a memory and a peripheral device. The transfer engine controls the buffer in accordance with a designating packet received from the preprocessor, so that data is transmitted between the memory and the peripheral device.

In this DMA controller, a designating packet is produced by the preprocessor according to the transfer modes to be supported by the transfer engine. Accordingly, the transfer engine may merely execute transferring of data in compliance with only the designating packet. Hence, this DMA controller is able to correspond to a plurality of transfer modes without significant increase in circuit complexity or area of the transfer engine.

Preferably, the designating packet includes:

transfer direction identification information, indicating a direction for transferring data from a memory to a peripheral device, or a direction for transferring data from a peripheral device to a memory;

a transfer start memory address, indicating an address of a memory for starting a data transfer; and

a transfer word count, indicating the number of words of data to be transferred at one time. When the transfer direction identification information indicates the direction for transferring data from the memory to the peripheral device, the transfer engine starts reading data beginning at the transfer start memory address, and controls the buffer, so that data for the number of words to be transmitted are read from the memory and are written to the buffer, and data are read from the buffer and written to the peripheral device. When the transfer direction identification information indicates the direction for transferring data from the peripheral device to the buffer, the transfer engine controls the buffer, so that data for the number of words to be transferred are read from the peripheral device and written to the buffer, writing data to the memory is started beginning with the transfer start memory address, and data are read from the buffer and written to the memory.

In this case, since data for the number of words to be transferred, which is included in the designating packet, is transferred between the memory and the peripheral device, the transfer engine does not need to identify bulk transfer or slice transfer.

Preferably, when data reading has ended, the transfer engine provides, for the preprocessor, the next transfer start address at which data are to be read, and when data writing has ended, provides, for the preprocessor, the next transfer start memory address to which data are to be written.

In this case, since the transfer engine provides the next transfer start memory address for the preprocessor, and a designating packet is provided for the transfer engine for the next data transfer, the data are sliced and transferred.

Preferably, the designating packet includes tag identification information that indicates reading of a tag. When the tag identification information indicates reading of a tag, the transfer engine reads a tag from the memory or the peripheral device, and transmits the tag to the preprocessor. Based on the received tag, the preprocessor designates a transfer start memory address and the number of words to be transferred.

In this case, the tag is read from the memory or the peripheral device, and is transmitted to the preprocessor. Then, data reading or writing is initiated beginning at the transfer start memory address written in the tag, and data for the number of words to be transferred, which are written in the tag, are transferred between the memory and the peripheral device.

Preferably, the designating packet includes: tag transfer identification information that indicates the transfer of a tag. When the tag transfer identification information indicates the transfer of a tag, the transfer engine writes, to the buffer, a tag read from the memory or the peripheral device.

In this case, since a tag read from the memory or the peripheral device is written to the buffer, a tag is also transferred with data between the memory and the peripheral device.

Preferably, the transfer engine includes a first and a second transfer engine. The first transfer engine controls the buffer for the transfer of data from the memory to the peripheral device, and the second transfer engine controls the buffer for the transfer of data from the peripheral device to the memory.

Since the transfer engine is divided into two sections, additional complexity is unnecessary when the bus protocol of the memory differs from the bus protocol of the peripheral device.

According to the present invention, a data transfer method, by a DMA controller comprising a buffer connected between a memory and a peripheral device and a transfer engine controlling the buffer, comprises the steps of:

producing a designating packet in compliance with a plurality of transferring modes different from one another and providing the designating packet with the transfer engine;

transferring data, by the transfer engine, from the memory to the peripheral equipment, according to the provided designating packet; and

transferring data, further by the transfer engine, from the peripheral equipment to the memory, according to the provided designating packet.

According to this data transferring method, a designating packet is produced in accordance with a transferring mode, and is transmitted to the transfer engine. Therefore, the transfer engine need only transfer data in accordance with the designating packet. Thus, the data transferring method can cope with multiple transfer modes, without employing a complicated transfer engine.

Preferably, the designating packet includes:

transfer direction identification information, indicating a direction for transferring data from a memory to a peripheral device, or a direction for transferring data from a peripheral device to a memory;

a transfer start memory address, indicating an address of a memory for starting a data transfer; and

a transfer word count, indicating the number of words of data to be transferred at one time. When the transfer direction identification information indicates the direction for transferring data from the memory to the peripheral device, reading of data is commenced at the transfer start memory address. At the same time data for the number of words to be transmitted are read from the memory and are written to the buffer, and data are read from the buffer and written to the peripheral device. When the transfer direction identification information indicates the direction for transfer from the peripheral device to the buffer, data for the number of words to be transferred are read from the peripheral device and written to the buffer, writing data to the memory begins with the transfer start memory address, and data are read from the buffer and written to the memory.

In this case, since data for the number of words to be transferred, which is included in the designating packet, is transferred between the memory and the peripheral device, the transfer engine does not need to identify bulk transfer or slice transfer modes.

Preferably, the data transferring method further comprises the steps of:

when data reading has ended, the transfer engine produces the next transfer start memory address at which data are to be read; and

when data writing has ended, the transfers engine generates the next transfer start memory address to which data are to be written.

In this case, since the transfer engine provides the next transfer start memory address for the preprocessor, and a designating packet is provided for the transfer engine for the next data transfer, the data are sliced and transferred.

Preferably, the designating packet includes tag identification information that indicates reading of a tag. The data transferring method includes reading a tag from the memory or a peripheral device when the tag identification information indicates reading of a tag; and employing the tag to designate a transfer start memory address and the number of words to be transferred.

In this case, the tag is read from the memory or the peripheral device. Then, data reading or writing is initiated beginning at the transfer start memory address written in the tag, and data for the number of words to be transferred, which are written in the tag, are transferred between the memory and the peripheral device.

Preferably, the designating packet includes tag transfer identification information that indicates transfer of a tag. The data transferring method includes

writing a tag read from memory to the buffer when the tag transfer identification information indicates transfer of a tag.

In this case, since a tag read from the memory or the peripheral device is written to the buffer, a tag is also transferred with data between the memory and the peripheral device.

### BRIEF DESCRIPTION OF THE DRAWINGS

FIG. 1 is a functional block diagram showing the configuration of a DMA controller according to a first embodiment of the invention.

FIG. 2 is a functional block diagram showing the arrangement of the transfer engine control circuit of the DMA controller shown in FIG. 1.

FIGS. 3A and 3B are timing charts showing the operations, in a bulk mode and in a slice mode, respectively, of the DMA controller shown in FIG. 1.

FIG. 4 is a memory map showing a tag in a memory that the DMA controller in FIG. 1 refers to in a chain mode.

FIGS. 5A to 5E are timing charts showing the operation of the DMA controller in FIG. 1 in chain modes.

FIG. 6 is a timing chart showing designating packets to be issued by the preprocessor of the DMA controller in FIG. 1 to the transfer engine.

The novel features believed to be characteristic of this invention are set forth in the appended claims. The invention itself, however, as well as other objects and advantages thereof, may be best understood by reference to the following detailed description of an illustrated preferred embodiment to be read in conjunction with the accompanying drawings.

### DETAILED DESCRIPTION OF THE PREFERRED EMBODIMENT

The preferred embodiment of the present invention will now be described in detail while referring to the drawings. The same reference numerals are employed throughout to denote identical or corresponding portions, and explanations for them will not be repeated.

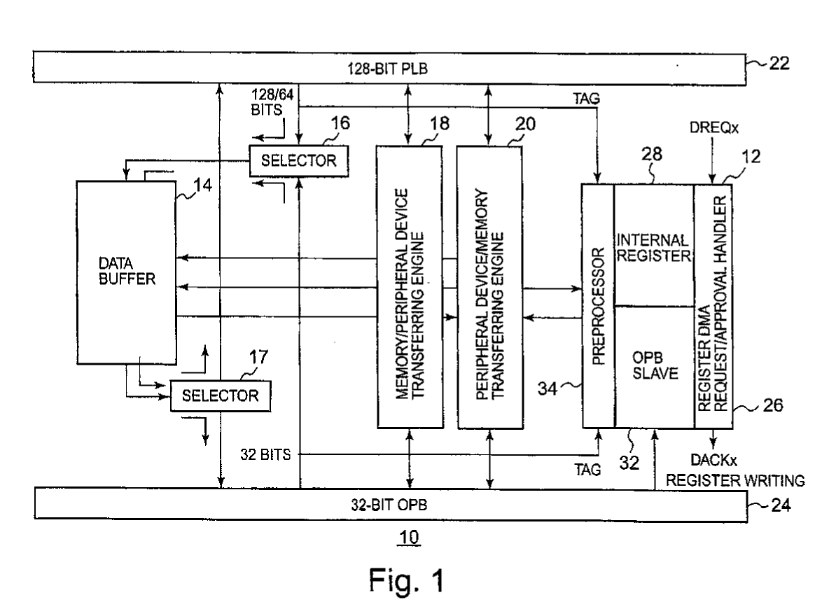

Referring to FIG. 1, a DMA controller 10 according to a first embodiment includes a transfer engine control circuit 12, a data buffer 14, selectors 16 and 17, a memory/peripheral device transfer engine 18 and a peripheral device/memory transfer engine 20.

Transfer engine control circuit 12 generates designating packets that are defined in advance in accordance with seven types of transfer modes, and provides these packets for the transfer engine 18 or 20.

Data buffer 14 is connected between a PLB (Processor Local Bus) 22 and an OPB (On-chip Peripheral Bus) 24. PLB 22 has a width of 128 or 64 bits, and is connected to a memory (not shown). OPB 24 has a width of 32 bits, and is connected to a peripheral device (not shown).

Selector 16 is connected to PLB 22 and OPB 24, and also to the input terminal of data buffer 14. Selector 16 selects either PLB 22 or OPB 24 and transmits to data buffer 14 data received via the selected bus 22 or 24. Selector 17 is connected to PLB 22 or to OPB 24, and also to the output terminal of data buffer 14. Selector 17 selects either PLB 22 or OPB 24, and transmits to the selected bus 22 or 24 data received from data buffer 14.

In accordance with a designating packet issued by transfer engine control circuit 12, memory/peripheral device transfer engine 18 controls data buffer 14 and selectors 16 and 17 for the transfer of data from the memory to the peripheral device. Further, in accordance with a designating packet issued by transfer engine control circuit 12, peripheral device/memory transfer engine 20 controls data buffer 14 and selectors 16 and 17 for the transfer of data from the peripheral device to the memory.

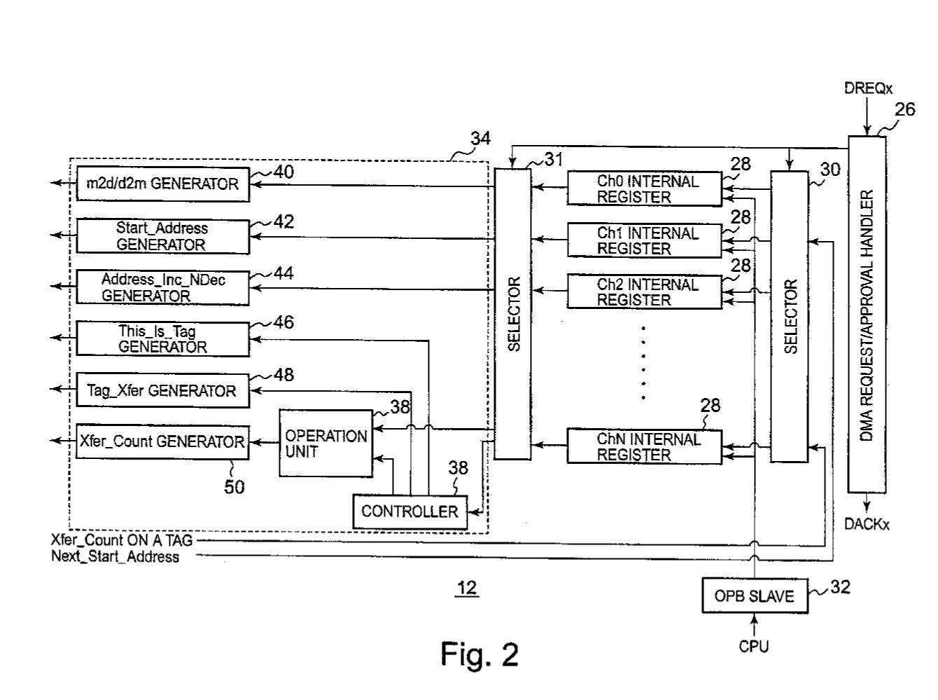

Referring to FIG. 2, transfer engine control circuit 12 includes DMA request/approval handler 26, plurality of internal registers 28, selectors 30 and 31, OPB slave 32 and preprocessor 34.

Upon receiving DMA request signals DREQ via separate channels, DMA request/approval handler 26 arbitrates requests for data transfers via the channels, transmits a selected channel number to selectors 30 and 31, and returns a DMA approval number DACKx to the selected channel.

Internal registers 28 are provided in correlation with channels, and are used to temporarily store various data transfer related parameters for corresponding channels.

Selectors 30 and 31 select one internal register 28 in accordance with the channel number selected by DMA request/approval handler 26. Selector 30 transmits, to selected internal register 28, transfer word count Xfer_Count on a tag, which is fed back from transfer engines 18 and 20, and the next transfer start memory address, Next_Start_Address. Selector 31 reads various parameters from the selected internal register 28, and transmits these parameters to preprocessor 34.

OPB slave 32 writes predetermined data to the selected internal register 28 in accordance with an instruction received from a CPU (not shown) via OPB 24 (FIG. 1).

Preprocessor 34 includes a controller 36, an operation unit 38, transfer direction identification parameter generator 40, transfer start memory address generator 42, address increment/decrement flag generator 44, tag identification flag generator 46, tag transfer identification flag generator 48 and transfer word count generator 50.

Controller 36 designates one of the seven transferring modes based on the parameters read from internal register 28 for the selected channel. In accordance with the transfer mode designated by controller 36, operation unit 38 directly transmits, to transfer word count generator 50, a transfer word count (hereinafter referred to as a “predetermined slice size”) that is set within internal register 28 for the selected channel, increments, by one, two or four, the transfer word count obtained from the tag, or compares the transfer word count obtained by the tag with the predetermined slice size.

Transfer direction identification parameter generator 40 produces transfer direction identification parameter m2d/d2m based on the parameters read from internal register 28 for the selected channel. The transfer direction identification parameter m2d/d2m indicates a direction of data transfer from a memory to a peripheral device, or a direction for the transfer of data from a peripheral device to a memory. When m2d=1 and d2m=0 has been established, data is transferred from the memory to the peripheral device, and when m2d=0 and d2m=1 has been established, data is transferred from the peripheral device to the memory.

The transfer start memory address generator 42 generates a transfer start memory address Start_Address based on the parameters read from the internal register 28 for the selected channel. The transfer start memory address Start_Address indicates the address in the memory at which the transfer of data should be started.

The address increment/decrement flag generator 44 generates an address increment/decrement flag Address_Inc_NDec based on the parameters read from internal register 28 for the selected channel. The address increment/decrement flag Address_Inc_NDec indicates whether an address at which to read or write data should be incremented or decremented. When Address_Inc_NDec=1, the address is incremented, and when Address_Inc_NDec=0, the address is decremented.

The tag identification flag generator 46 generates a tag identification flag This_Is_Tag in accordance with a transferring mode designated by controller 36. The tag identification flag This_Is_Tag indicates either the fetching of a tag or the transfer of a tag. When This_Is_Tag=1, a tag is fetched by the transfer engine control circuit 12. When This_Is_Tag=0, data are transferred between the memory and the peripheral device.

The tag transfer identification flag generator 48 generates a tag transfer identification flag Tag_Xfer in accordance with a transferring mode designated by the controller 36. The tag transfer identification flag Tag_Xfer indicates whether a fetched tag should be transferred, i.e., should be written to data buffer 14.

Transfer word count generator 50 generates a transfer word count Xfer_Count in accordance with the calculation results obtained by operation unit 38. The transfer word count Xfer_Count indicates the number of words of data to be transmitted at one time.

Preprocessor 34 provides a designating packet that include these parameters for the memory/peripheral device transfer engine 18 or the peripheral device/memory transfer engine 20.

DMA controller 10 utilizes seven types of transfer modes, specifically, (1) a bulk mode, (2) a slice mode, (3) a chain mode C1, (4) a chain mode C2, (5) a chain mode C3, (6) a chain mode C4 and (7) a chain mode C5. These transfer modes will now be described.

(1) Bulk Mode

In bulk mode, data is collectively transferred, without being sliced. The detailed process performed in this mode will be described below.

Transfer direction identification parameters of m2d=1 and d2m=0, or of m2d=0 and d2m=1 are read from internal register 28 for the selected channel, and are designated for the transfer direction identification parameter generator 40. Furthermore, the transfer start memory address Start_Address is read from the same internal register 28, and is designated for the transfer start memory address generator 42. In addition, the address increment/decrement flag Address_Inc_NDec=1 or 0 is read from the internal register 28 for the selected channel, and is designated for the address increment/decrement flag generator 44. Further, controller 36 detects the bulk mode, and accordingly, designates the tag identification flag This_Is_Tag=0 for the tag identification flag generator 46, and the tag transfer identification flag Tag_Xfer=0 for the tag transfer identification flag generator 48. Moreover, transfer word count Xfer_Count is read from internal register 28 for the selected channel, and is designated for transfer word count generator 50, without being changed by operation unit 38.

When m2d=1 and d2m=0 are established, preprocessor 34 transmits a designating packet that includes these parameters to memory/peripheral device transfer engine 18, or when m2d=0 and d2m=1 are established, preprocessor 34 transmits a designating packet to peripheral device/memory transfer engine 20.

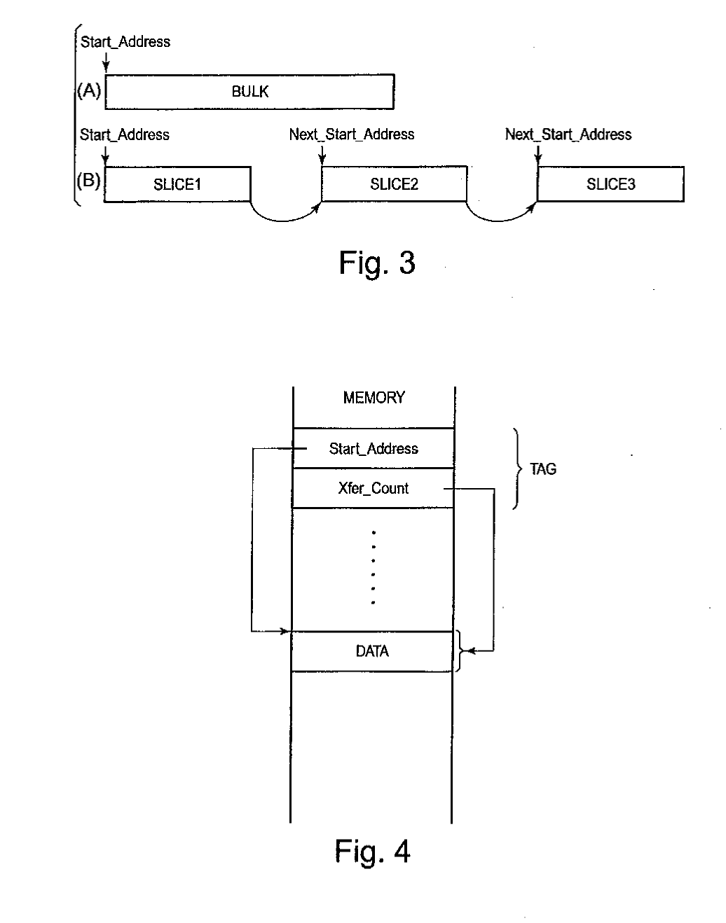

As shown in FIG. 3(A), memory/peripheral device transfer engine 18 reads bulk data from the memory equivalent to the word count Xfer_Count, and writes the bulk data to data buffer 14 via selector 16. Further, memory/peripheral device transfer engine 18 transmits to peripheral device, via selector 17, data that are read from data buffer 14. The reading of data from the memory is performed beginning at the transfer start memory address Start_Address. This address is incremented by one when Address_Inc_NDec=1 or is decremented by one when Address_Inc_NDec=0.

Peripheral device/memory transfer engine 20 reads from the peripheral device bulk data equivalent to the transfer word count Xfer_Count, and writes the bulk data to data buffer 14 via selector 16. Further, peripheral device/memory transfer engine 20 writes to the memory, via selector 17, data read from the data buffer 14. The writing of data to the memory is performed beginning with the transfer start memory address Start_Address. This address is incremented by one when Address_Inc NDec=1 or is decremented by one when Address_Inc_NDec=0.

(2) Slice Mode

In slide mode, data to be transferred is sliced every n words to provide m sets of n data words. The parameters m2d/d2m, Start_Address, Address_Inc_NDec, This_Is_Tag, Tag_Xfer=0 and the transfer word count Xfer_Count are designated in the same manner as described in the Bulk mode.

However, as shown in FIG. 3(B), the transfer of the first data slice is performed beginning at the transfer start memory address Start_Address provided by the CPU, while for the second and the following data slice, the transfer is started beginning at the next transfer start memory address Next_Start_Address, which is fed back from the transfer engines 18 and 20. Therefore, in slice mode, after each set of sliced data has been transferred, transfer engines 18 and 20 increment the last address by one and transmit the thus obtained address to transfer engine control circuit 12 as the next transfer start memory address Next_Start_Address. The next transfer start memory address Next_Start_Address is then written to internal register 28 for the pertinent channel as the transfer start memory address Start_Address.

In this case, as shown in FIG. 3(B), transfer engines 18 and 20 slice data every transfer word count Xfer_Count number of words, and permit the memory and the peripheral device to transfer the data set.

(3) Chain Mode C1

Chain mode C1 is also called a descriptor mode. In the chain mode C1, the transfer start memory address Start_Address and the transfer word count Xfer_Count are not obtained from the CPU but from the memory. As shown in FIG. 4, the transfer start memory address Start_Address and the transfer word count Xfer_Count are stored as tags (descriptors) in the memory.

In the chain mode C1, a tag is read first and data are transferred next. Data are read beginning at the transfer start memory address Start_Address included in the tag, and the amount of data transferred is equivalent to the transfer word count Xfer_Count also included in the tag. Especially in the chain mode C1, the tag is a single word, and is also transferred. Further, data are transferred in bulk from the memory to the peripheral device. The detailed process performed in the chain mode C1 will be described below.

In order to read a tag from the memory, first, m2d=1 and d2m=0 are designated the transfer direction identification parameters and the transfer start memory address Start_Address is read from the internal register 28 for the selected channel and is designated the transfer start memory address for a tag. Further, Address_Inc_NDec=1 is designated the address increment/decrement flag and This_Is_Tag=1 is designated the tag identification flag. Also, Tag_Xfer=1 is designated the tag transfer identification flag and the designated transfer word count Xfer_Count is a single word.

Since m2d=1 and d2m=0, preprocessor 34 provides a designating packet that includes these parameters to memory/peripheral device transfer engine 18. The memory/peripheral device transfer engine 18 accesses the memory and reads one word of data, i.e., a tag, at the transfer start memory address Start_Address, and transmits the tag to transfer engine control circuit 12. The tag is written to the internal register 28 for the corresponding channel, and is also written to the data buffer 14.

Next, to transfer data from the memory to the peripheral device, m2d=1 and d2m=0 are designated the transfer direction identification parameters. The transfer start memory address Start_Address obtained from the tag is read from internal register 28 for the channel and designated as the data transfer start memory address. In addition, Address_Inc_NDec=1 or 0 is designated the address increment/decrement flag, and This_Is_Tag=0 is designated the tag identification flag and Tag_Xfer=1 is designated the tag transfer identification flag. Further, the transfer word count Xfer_Count obtained from the tag is incremented by one (the number of words in a tag) by the operation unit 38, and the transfer word count Xfer_Count is designated the total word count.

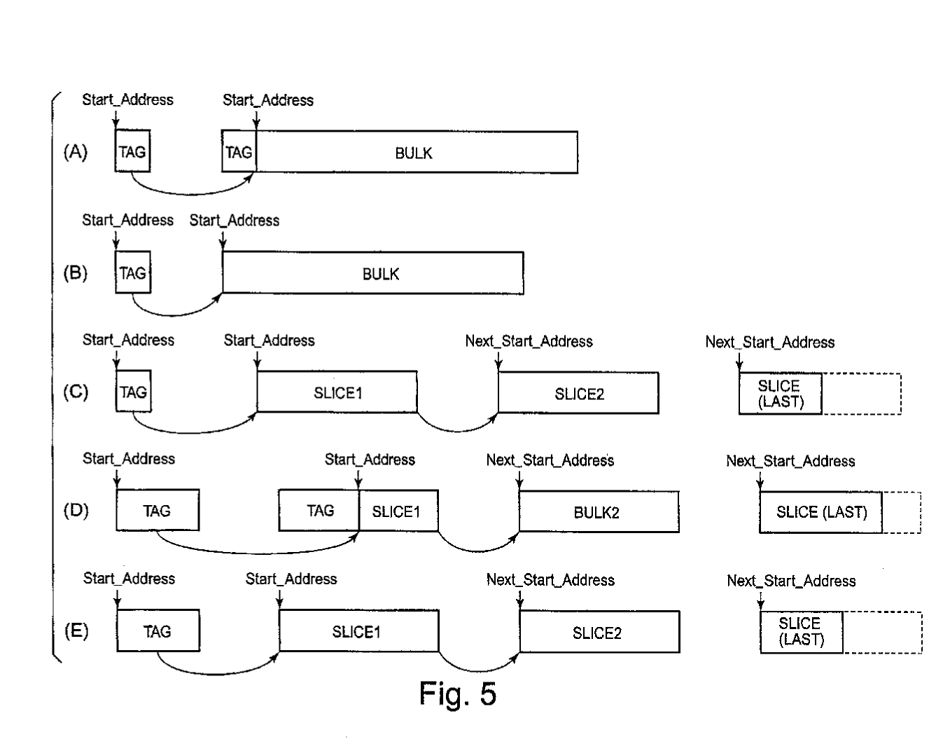

Since m2d=1 and d2m=0, preprocessor 34 provides a designating packet that includes these parameters to the memory/peripheral device transfer engine 18. As a result, as shown in FIG. 5(A), the memory/peripheral device transferr engine 18 transmits a one word tag, and thereafter transfers, from the memory to the peripheral device, bulk data in an amount equivalent to the transfer word count Xfer_Count.

(4) Chain Mode C2

In chain mode C2, unlike chain mode C1, a tag is not transferred. Therefore, for the first tag read from the memory, the same parameters are designated as in the chain mode C1, except that Tag_Xfer=0 is designated the tag transfer identification flag. Further, the same parameters as in the chain mode C1 are also designated for the next transfer of data, except that the transfer word count Xfer_Count obtained from the tag is designated, unchanged, the transfer word count.

In this case, as shown in FIG. 5(B), the memory/peripheral device transfer engine 18 transfers, from the memory to the peripheral device, bulk data (not including a tag) equivalent in amount to the transfer word count Xfer_Count.

(5) Chain Mode C3

In the chain mode C3, a tag consists of two words, and is not to be transferred. Further, data are sliced and transferred from the memory to the peripheral device. Therefore, in order to first read a tag from the memory, the same parameters as in the chain mode C2 are designated, except that the transfer word count Xfer_Count is two words. Further, for the next transfer of data, the same parameters as in the chain mode C2 are designated, except for the transfer word count Xfer_Count. The setup for the transfer word count Xfer_Count is performed as follows.

The operation unit 38 compares with a predetermined slice size (a designated transfer word count in the internal register 28 for the selected channel) the transfer word count obtained from the tag, or the number of words (hereinafter referred to as the number of words remaining) of data remaining that have not been transferred. When the transfer word count obtained from the tag, or the number of remaining words is greater than the predetermined slice size, the transfer word count Xfer_Count is set to the predetermined slice size. In other cases, the transfer word count Xfer_Count is set to the transfer word count obtained from the tag, or the number of remaining words.

In this case, as shown in FIG. 5(C), the memory/peripheral device transfer engine 18 slices data every transfer word count Xfer_Count number of words, and transfers the data from the memory to the peripheral device.

(6) Chain Mode C4

In the chain mode C4, unlike the chain mode C3, a tag consists of four words, and is also transferred. Therefore, in order to first read a tag from the memory, the same parameters are designated as in the chain mode C3, except that Tag_Xfer=1 is designated the tag transfer identification flag and the transfer word count Xfer_Count is set to four words. Further, for the next transfer of data, the same parameters are designated as in the chain mode C3, except for the transfer word count Xfer_Count. The setup of the transfer word count Xfer_Count will now be described.

The operation unit 38 compares, with a predetermined slice size, the total word count that is obtained by adding four words, equivalent to one tag, to the transfer word count obtained from the tag or the number of remaining words. When the total word count is greater than the predetermined slice size, the transfer word count Xfer_Count is designated the predetermined slice size. In other cases, the total word count is designated the transfer word count.

In this case, as shown in FIG. 5(D), the memory/peripheral device transfer engine 18 transfers a tag of four words, and then slices data every transfer word count Xfer_Count number of words, and transfers the obtained data sets from the memory to the peripheral device.

(7) Chain Mode C5

In the chain mode C5, unlike chain mode C3, a tag consists of four words, and data are transferred from the peripheral device to the memory. It should be noted that the tag is not transferred. Therefore, to first read a tag from the memory, the same parameters are designated as in the chain mode C3, except for the transfer direction identification parameter m2d/d2m, the transfer start memory address Start_Address and the transfer word count Xfer_Count. Also, m2d=0 and d2m=1 are designated the transfer direction identification parameters, the transfer start memory address Start_Address is set as a dummy address (e.g., 0), and the designated length of the transfer word count Xfer_Count is four words.

Further, for the next transfer of data, the same parameters are designated as in the chain mode C3, except for the transfer direction identification parameter m2d/d2m. Also, m2d=0 and d2m=1 are designated the transfer direction identification parameters. It should be noted that in the chain mode C5, since data are to be transferred from the peripheral device to the memory, the Start_Address obtained from the tag that is designated the transfer start memory address does not indicate a transfer source, but a transfer destination, i.e., the address in the memory.

In this case, as shown in FIG. 5(E), the peripheral device/memory transfer engine 20 slices data every transfer word count Xfer_Count number of words, and transfers the data from the peripheral device to the memory.

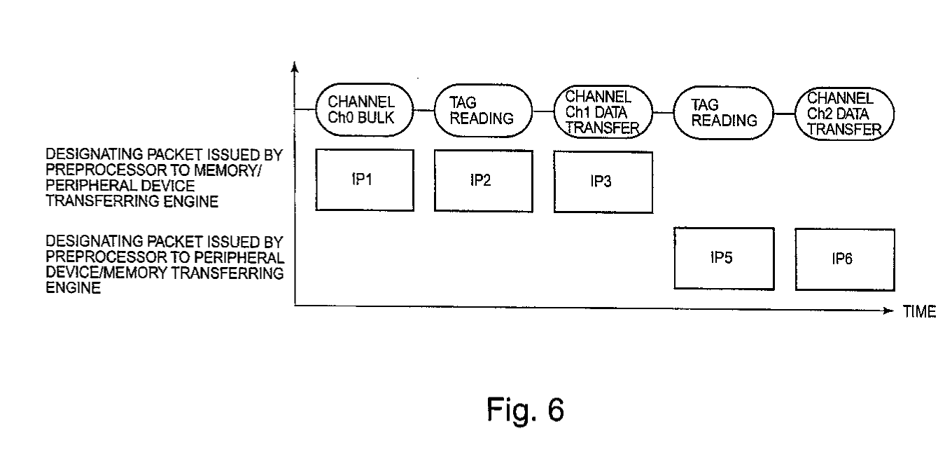

While referring to FIG. 6, an explanation will be given for the operation performed when the DMA request/approval handler 26 accepts requests in the channel Ch0, channel Ch1 and channel Ch2 order.

When a request is received via the channel Ch0 for a bulk data transfer from the memory to the peripheral device, preprocessor 34 issues to the memory/peripheral device transfer engine 18 a designating packet IP1 that represents the requested action.

When a request is received via the channel Ch1 for a data transfer, performed in a chain mode, from the memory to the peripheral device, first, the preprocessor 34 transmits to the memory/peripheral device transfer engine 18 a designating packet IP2 for reading a tag, and then transmits to the memory/peripheral device transfer engine 18 a designating packet IP3 for the transfer of data.

When a request is received via the channel Ch2 for a data transfer, performed in a chain mode, from the peripheral device to the memory, preprocessor 34 first transmits a designating packet IP4 for reading a tag to the peripheral device/memory transfer engine 20, and then a designating packet IP5 for the transfer of data to the peripheral device/memory transfer engine 20.

According to the embodiment of the present invention, preprocessor 34 generates a designating packet in consonance with the seven types of transfer modes, and provides the designating packet for transfer engines 18 and 20. Therefore, transfer engines 18 and 20 need only transmit data in accordance with the designating packet, so that the seven transfer modes can be handled without the undue complxity of the circuit structure. In addition, since an amount of data equivalent to the transfer word count Xfer_Count included in the designating packet are transferred, transfer engines 18 and 20 do not need to identify either a bulk transfer or a slice transfer. Further, since transfer engines 18 and 20 provide the next transfer start memory address Next_Start_Address, preprocessor 34 can transmit a designating packet for the next data transfer to transfer engines 18 and 20. As a result, data can be sliced and transferred.

In the above embodiments, seven transfer modes have been employed. However, the number of modes is not limited to seven. Several of the seven modes may not be provided, or other, additional transfer modes may be provided.

While the invention has been described with reference to a preferred embodiment of embodiments it will be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all the embodiments falling within the scope of the appended claims.

1. A direct memory access controller comprising:
a preprocessor for generating a designating packet in compliance with a plurality of distinct transfer modes;
a buffer coupled between a memory and a first peripheral device; and
a transfer engine for controlling said buffer to transfer data between said memory and said first peripheral device according to the designating packet provided by said preprocessor.

2. A direct memory access controller according to claim 1, wherein said designating packet includes:
transfer direction identification information that indicates a direction for transferring data from a memory to a peripheral device or a direction for transferring data from a peripheral device to a memory;
a transfer start memory address that indicates an address of a memory for starting a data transfer; and
a transfer word count that indicates the number of words of data to be transferred at one time,
wherein, when said transfer direction identification information indicates said direction for transferring data from the memory to the peripheral device, said transfer engine starts reading data beginning at the transfer start memory address and controls said buffer, so that data for the number of words to be transmitted are read from the memory and are written to said buffer, and data are read from said buffer and written to the peripheral device, and
wherein, when said transfer direction identification information indicates the direction for transferring data from the peripheral device to said buffer, said transfer engine controls said buffer, so that data for the number of words to be transferred are read from the peripheral device and written to said buffer, writing data to said memory is started beginning with the transfer start memory address, and data are read from said buffer and written to the memory.

3. A direct memory access controller according to claim 2, wherein, when data reading has ended, said transfer engine provides, for said preprocessor, the next transfer start address at which data are to be read, and when data writing has ended, provides, for said preprocessor, the next transfer start memory address to which data are to be written.

4. A direct memory access controller according to claim 3, wherein said designating packet includes tag identification information that indicates reading of a tag; wherein, when said tag identification information indicates reading of a tag, said transfer engine reads a tag from the memory or the peripheral device, and transmits the tag to said preprocessor; and wherein, based on the received tag, said preprocessor designates a transfer start memory address and the number of words to be transferred.

5. A direct memory access controller according to claim 4, wherein said designating packet includes: tag transfer identification information that indicates the transfer of a tag, and wherein, when said tag transfer identification information indicates the transfer of a tag, said transfer engine writes, to said buffer, a tag read from the memory or the peripheral device.

6. A direct memory access controller according to claim 5, wherein said transfer engine includes:
a first transfer engine for controlling said buffer to transfer data from the memory to the peripheral device; and
a second transfer engine for controlling said buffer to transfer data from the peripheral device to the memory.

7. A data transfer method using a direct memory access controller comprising a buffer connected between a memory and a first peripheral device and a transfer engine controlling the buffer, said method comprising the steps of:
generating a designating packet in compliance with a plurality of distinct transfer modes and providing said designating packet to said transfer engine;
transferring data, by said transfer engine, from the memory to the first peripheral device, according to said provided designating packet; and
transferring data, further by said transfer engine, from the first peripheral device to the memory, according to the provided designating packet.

8. A data transfer method according to claim 7, whereby said designating packet includes:
transfer direction identification information that indicates a direction for transferring data from a memory to a peripheral device, or a direction for transferring data from a peripheral device to a memory;
a transfer start memory address that indicates an address of a memory for starting a data transfer; and
a transfer word count that indicates the number of words of data to be transferred at one time, and
whereby, at said step of said engine transfer engine transferring data, when said transfer direction identification information indicates said direction for transferring data from the memory to the peripheral device, reading of data is started beginning at the transfer start memory address, data for the number of words to be transmitted are read from the memory and are written to said buffer, and data are read from said buffer and written to the peripheral device, or, when said transfer direction identification information indicates the direction for transferring data from the peripheral device to said buffer, data for the number of words to be transferred are read from the peripheral device and written to said buffer, writing data to said memory is started beginning with the transfer start memory address, and data are read from said buffer and written to the memory.

9. A data transferring method according to claim 8, further comprising the steps of:
when data reading has ended, said transfer engine producing the next transfer start memory address at which data are to be read; and
when data writing has ended, said transfer engine generating the next transfer start memory address to which data are to be written.

10. A data transferring method according to claim 9, whereby said designating packet includes tag identifica-tion information that indicates reading of a tag, said data transferring method further comprising the steps of:
when said tag identification information indicates reading of a tag, said transfer engine reading a tag from the memory;
when said tag identification information indicates reading of a tag, said transfer engine reading a tag from the peripheral device; and
employing the tag to designate a transfer start memory address and the number of words to be transferred.

11. A data transferring method according to claim 10, whereby said designating packet includes tag transfer identification information that indicates transfer of a tag, said data transferring method further comprising the steps of:
when said tag transfer identification information indicates transfer of a tag, said transfer engine writing, to said buffer, a tag read from memory; and
when said tag transfer identification information indicates transfer of a tag, said transfer engine writing to said buffer a tag read from memory.
